(19) United States
(12) Patent Application Publication
(10) Pub. No.: US 2017/0193094 A1
(43) Pub. Date: Jul. 6, 2017

(54) METHOD AND ELECTRONIC DEVICE FOR OBTAINING AND SORTING ASSOCIATED INFORMATION

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Zhongbin TONG, Beijing (CN)

(21) Appl. No.: 15/245,710

(22) Filed: Aug. 24, 2016

Related U.S. Application Data
(63) Continuation of application No. PCT/CN2016/089451, filed on Jul. 8, 2016.

(30) Foreign Application Priority Data
Dec. 31, 2015 (CN) 201511029314.5

(51) Int. Cl. G06F 17/30

(52) U.S. Cl. CPC G06F 17/30696; G06F 17/30657; G06F 17/30675; G06F 17/30958; G06F 17/30705

(57) ABSTRACT

A method for obtaining and sorting associated information is disclosed. The method includes: at an electronic device, obtaining a subject name and a subject attribute inputted by a user; obtaining associated information of the subject name according to the subject attribute; obtaining contents corresponding to the associated information; presenting the contents corresponding to the associated information to a user in sequence; and allowing the user to download and view the contents corresponding to the associated information.

### CROSS REFERENCE TO RELATED APPLICATIONS

The present disclosure is a continuation application of PCT International patent application No. PCT/CN2016/089451, filed on Jul. 8, 2016, which claims priority to Chinese Patent Application No. 201511029314.5, filed with the Chinese Patent Office on Dec. 31, 2015, both of which are herein incorporated by reference in their entireties.

### TECHNICAL FIELD

The present disclosure relates to the field of information technologies, and particularly, to a method and an electronic device for obtaining and sorting associated information.

### BACKGROUND

Information about a certain subject (e.g., a TV play, a star and etc) is relatively disordered. Therefore, if a user desires to obtain a plurality of pieces of information of the subject (e.g., such information as TV plays, portraits, songs, news and introductions associated with Hu Ge), the user needs to search in a plurality of APPs or web pages and the sequence in which the searching results are presented is not sorted according to the extent to which the pieces of information are needed by the user.

### SUMMARY

A method for obtaining and sorting associated information is provided in an embodiment of the present disclosure. The method includes: at an electronic device, obtaining a subject name and a subject attribute inputted by a user; obtaining associated information of the subject name according to the subject attribute; obtaining contents corresponding to the associated information; presenting the contents corresponding to the associated information to a user in sequence; and allowing the user to download and view the contents corresponding to the associated information.

An electronic device is provided in another embodiment of the present disclosure. The electronic device includes at least one processor and a memory communicably connected with the at least one processor for storing instructions executable by the at least one processor, wherein execution of the instructions by the at least one processor causes the at least one processor to:

obtain a subject name and a subject attribute inputted by a user;

obtain associated information of the subject name according to the subject attribute;

obtain contents corresponding to the associated information;

present the contents corresponding to the associated information to a user in sequence; and

allow the user to download and view the contents corresponding to the associated information.

A non-transitory computer-readable storage medium is provided in still another embodiment of the present disclosure. The non-transitory computer-readable storage medium stores executable instructions, wherein when executed by an electronic device, causes the electronic device to:

obtain a subject name and a subject attribute inputted by a user;

obtain associated information of the subject name according to the subject attribute;

obtain contents corresponding to the associated information;

present the contents corresponding to the associated information to a user in sequence; and

allow the user to download and view the contents corresponding to the associated information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of a method for obtaining and sorting associated information according to an embodiment of the present disclosure;

FIG. 2 is a structural diagram of a system for obtaining and sorting associated information according to an embodiment of the present disclosure;

FIG. 3 is a flowchart diagram of an incremental clustering process based on congruence in a method for obtaining and sorting associated information according to an embodiment of the present disclosure;

FIG. 4 is a flowchart diagram of a process for sorting subject links according to an initial result set in a method for obtaining and sorting associated information according to an embodiment of the present disclosure; and

FIG. 5 is a structural diagram of a video playing terminal according to an embodiment of the present disclosure.

### DETAILED DESCRIPTION

To make the objective, technical solutions and advantages of the present disclosure clearer, the technical solutions of embodiments of the present disclosure will be described hereinbelow clearly, fully and in detail with reference to the attached drawings. Obviously, the embodiments described herein are only some of but not all of the embodiments of the present disclosure. All other embodiments that can be obtained by those of ordinary skill in the art upon reviewing the embodiments of the present disclosure shall fall within the scope of the present disclosure.

According to an embodiment, a method for obtaining and sorting associated information is provided.

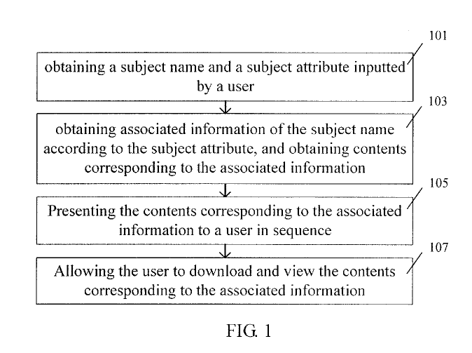

As shown in FIG. 1, the method for obtaining and sorting associated information according to the embodiment of the present disclosure includes:

In Step 101: obtaining a subject name and a subject attribute inputted by a user;

In Step 103: obtaining associated information of the subject name according to the subject attribute, and obtaining contents corresponding to the associated information;

In Step 105: presenting the contents corresponding to the associated information to a user in sequence; and

In Step 107: allowing the user to download and view the contents corresponding to the associated information.

For example, the subject name “Lang Ya Bang” and the subject attribute “TV play” are inputted by the user. The associated information of the subject name obtained according to the subject attribute (i.e., the associated information corresponding to the subject attribute “TV play”) includes “Story video, opening song, ending song, leading actor, leading actress, director, scriptwriter, type” or the like information. The contents corresponding to the associated information refer to contents of the aforesaid associated information in the TV play “Lang Ya Bang”, e.g., the video corresponding to the “story video”, audios corresponding to the “opening song” and the “ending song”, Hu Ge corresponding to the “leading actor”, Liu Tao corresponding to the “leading actress”, Kong Sheng corresponding to the “director”, Hai Yan corresponding to the “scriptwriter”, a costume play corresponding to the “type”, and so on.

In some exemplary embodiments, obtaining associated information of the subject name according to the subject attribute includes:

searching for initial associated information of the subject name along a link associated with the subject attribute, extracting contents corresponding to at least one of the initial associated information in the form of a vector from the initial associated information of the subject name, and storing the content corresponding to the initial associated information, the subject link and the searching time in a correlated manner;

calculating a density-based similarity between contents corresponding to every two of the initial associated information, and determining an optimal number of classes of a graph cluster according to the density-based similarities between the contents corresponding to the initial associated information; and

accessing an updated subject corresponding to the subject again according to the link associated with the subject attribute and searching for updated subject information, updating the contents corresponding to the initial associated information into contents corresponding to the new associated information according to the updated subject information, and storing the contents corresponding to the new associated information, the subject link and the updating time in a correlated manner.

In some exemplary embodiments, calculating a density-based similarity between contents corresponding to every two of the initial associated information includes:

defining a regional homogeneity and a global homogeneity of a graph clustering method;

obtaining a density-based line segment length distance expression according to the regional homogeneity and the global homogeneity of the graph clustering method;

calculating a density-based distance between the contents corresponding to the two of the initial associated information according to the density-based line segment length distance expression; and

obtaining the density-based similarity between the contents corresponding to the two of the initial associated information according to the density-based distance between the contents corresponding to the two of the initial associated information.

The aforesaid regional homogeneity means that similarity exists for data having closer distances from each other in terms of the spatial positions; and the global homogeneity means that similarity exists for data located in a same manifold. The Gaussian kernel function can only reflect the regional homogeneity but not take the global homogeneity into consideration, so it can not fully reflect datasets that are complexly distributed. To account for the global homogeneity, the spatial density of contents corresponding to the initial associated information must be considered.

The density-based line segment length is defined as shown in Formula (1):

L(x,y)=ρ^{dist(x,y)}−1 (1)

In Formula (1), dist(x, y) represents a Euclidean distance between two points, ρ is a scaling factor greater than 1. Thus, by adjusting the magnitude of ρ, the density-based distance between two points can be adjusted so that a sum of distances between multiple points in a region having a larger density is smaller than a distance between two points in a region having a smaller density, thus accomplishing the purpose of taking the global homogeneity into consideration. Let the edge set be E={L(a,b)}. Let V={V1, V2, . . . , Vn}εV represents paths connecting the points V₁ and V₁ shown to have a length Error! Reference source not found. in the figure, where the edge Error! Reference source not found. (vₖ,vₖ₊₁) ε E, 1≦k≦1−1. Then the distance between a data point xᵢ and a data point xⱼ is:

$$D ( {x}_{i} , {x}_{j} ) = min {\sum }_{k = 1}^{l - 1} L ( {v}_{k} , {v}_{k + 1} ) \qquad ( 2 )$$

This distance measure enlarges the inter-cluster spacing and reduces the intra-cluster spacing. On the basis of this, the density-based similarity measure is defined as follows:

$$W ( {x}_{i} , {x}_{j} ) = \frac{1}{D ( {x}_{i} , {x}_{j} ) + 1} \qquad ( 3 )$$

Adding 1 to the denominator is to prevent a case where the distance measure is 0. As compared with the Gaussian kernel function, the parameters in this formula are less sensitive, and this method fully takes the global homogeneity into consideration.

In some exemplary embodiments, determining an optimal number of classes of a graph cluster according to the density-based similarities between the contents corresponding to the initial associated information includes:

creating a similarity matrix from the density-based similarities between the contents corresponding to every two of the initial associated information, wherein a row vector of the similarity matrix represents a content corresponding to one of the initial associated information and a column vector represents a weight value of a content feature term corresponding to one of the initial associated information;

calculating in the similarity matrix an average of weight values of content feature terms corresponding to all the initial associated information, an average of the content feature terms corresponding to any intra-graph-cluster initial associated information, a population variance of content datasets corresponding to all the initial associated information, a variance of any intra-graph-cluster dataset, and a variance of any inter-graph-cluster dataset; and

calculating the optimal number of classes of the graph cluster by means of the C-H exponent defined variance ratio standard according to the variance of any intra-graph-cluster dataset and the variance of any inter-graph-cluster dataset.

Assuming that there are content data corresponding to m n-dimensional initial associated information in the content dataset corresponding to the initial associated information, then a m×n similarity matrix W is formed according to the similarity measures, where a row vector represents a content corresponding to one of the initial associated information, a column vector represents a weight value of a content feature term corresponding to one of the initial associated information, and xᵢ represents a vector of the i^{th} column.

Several variables will be defined as follows:

an average of all the data feature terms is:

$$\overline{x} = \frac{1}{n} {\sum }_{i = 1}^{n} {x}_{i} . \qquad ( 4 )$$

an average of content feature terms corresponding to the intra-cluster initial associated information is:

$${μ}_{j} = \frac{1}{\vert {c}_{j} \vert} {\sum }_{{x}_{i} ∈ {C}_{j}} {x}_{i} , \qquad ( 5 )$$

where Error! Reference source not found. represents the number of contents corresponding to the initial associated information in the class cⱼ.

The population variance of the dataset is:

$${S}^{l} = {\sum }_{i = 1}^{m} ( {x}_{i} - \overline{x} ) {( {x}_{i} - \overline{x} )}^{T} . \qquad ( 6 )$$

The intra-cluster variance of the dataset is:

$${S}_{w}^{l} ( k ) = {\sum }_{j = 1}^{k} {\sum }_{{x}_{i} ∈ {C}_{j}} ( {x}_{i} - {μ}_{j} ) {( {x}_{i} - {μ}_{j} )}^{T} . \qquad ( 7 )$$

The inter-cluster variance of the dataset is:

$${S}_{h}^{l} ( k ) = {\sum }_{j = 1}^{k} \vert {c}_{j} \vert ( \overline{{x}_{i}} - {μ}_{j} ) {( \overline{{x}_{i}} - {μ}_{j} )}^{T} . \qquad ( 8 )$$

In the aforesaid formulae, the population variance Error! Reference source not found. is a constant, and the target function is

$$\{ \begin{matrix}min {S}_{w}^{l} ( k ) \\ max {S}_{h}^{l} ( k )\end{matrix} . \qquad ( 9 )$$

In fact, the solutions of the two target functions are consistent with each other, and the following can be obtained by extending the aforesaid formulae:

S_{w}^{l}(k)+Sₕ^{l}(k)=S^{l} (10).

The C-H exponent defined variance ratio standard is used, as shown in Formula (11), and a k value at which S_{k,m} reaches the first regional maximum value is just the optimal number of classes.

$${S}_{k , m} = \frac{( m - k ) {S}_{h}^{l} ( k )}{( k - 1 ) {S}_{w}^{l} ( k )} . \qquad ( 11 )$$

As can be seen from the above description, in order to find the optimal number of classes, it is needed to iterate the clustering algorithm repeatedly. Obviously, the efficiency of the sorting algorithm would be even lower if this method is applied to the graph clustering algorithm, so a k-means algorithm presenting a higher clustering efficiency is adopted as the basic algorithm for finding the optimal number of classes in the embodiments of the present disclosure. This avoids the problem of using a complex optimization algorithm to find an initial cluster center, thus reducing the computational complexity and increasing the clustering speed.

In some exemplary embodiments, presenting the contents corresponding to the associated information to the user in sequence includes:

calculating a class center vector and a class average of the graph cluster, calculating a connectivity between the content corresponding to the new associated information and all the existing graph cluster classes, determining whether to add the content corresponding to the new associated information into a pre-existing class created using the graph clustering method according to the connectivity between the content corresponding to the new associated information and all the existing graph cluster classes, and determining whether the graph cluster needs to be combined with other graph clusters according to the class center vector and the class average of each of the graph cluster classes; and

combining the subject name and the subject attribute inputted by the user into a subject vector, calculating a relevancy between the subject vector and the existing graph cluster classes, creating an initial result set of the subject link, calculating normalized weight values of the relevancy of the content corresponding to each of the associated information in the initial result set and the PageRank value, and sorting the contents in the order of the normalized weight values of the relevancy and the PageRank value for presentation to the user.

In some exemplary embodiments, determining whether to add the content corresponding to the new associated information into a pre-existing class created using the graph clustering method according to the connectivity between the content corresponding to the new associated information and all the existing graph cluster classes includes:

sorting the connectivity between the content corresponding to each of the new associated information and all the existing graph cluster classes in the order of magnitudes of the connectivities;

if the greatest connectivity of the contents corresponding to the new associated information is larger than a first threshold and a difference in absolute values of the greatest connectivity and the second greatest connectivity is larger than a second threshold, then add the content corresponding to the new associated information into the graph cluster corresponding to the greatest connectivity, and updating the class center vector and the class average of the graph cluster;

if the greatest connectivity of the content corresponding to the new associated information is larger than the first threshold but the difference in absolute values of the greatest connectivity and the second greatest connectivity is not larger than the second threshold, then temporarily storing the content corresponding to the new associated information into the graph cluster corresponding to the greatest connectivity, and labeling the content corresponding to the new associated information but not updating the class center vector and the class average of the graph cluster; and

if the greatest connectivity of the content corresponding to the new associated information is not larger than the first threshold, then classifying the content corresponding to the new associated information into a new graph cluster class and calculating a class center vector and a class average of the new graph cluster.

Because the content information of the subject link is updated very frequently, it is possible that the class features obtained by the clustering method do not match the content data corresponding to the new associated information. Therefore, it is necessary to re-calculate the extracted class information, and usually this is accomplished through re-clustering or by an incremental clustering method. Because what is processed now is the subject information for which the size of dataset is inestimable, performing re-clustering each time the class features do not match the content data corresponding the new associated information not only wastes the computational resources but also causes untimely updating of the information, and this prevents the searching engine from providing up-to-date information.

For content data corresponding to the new associated information, the connectivity of the content data with each class is determined. If the connectivity is larger than a certain threshold, then the content corresponding to the new associated information is classified into this class, and otherwise, the content corresponding to the new associated information is independently classified as a class.

On the basis of this principle, the content corresponding to the new associated information can be clustered. However, the clustering result cannot be adjusted once the content corresponding to the new associated information has been processed; that is to say, once content of a certain piece of associated information is falsely clustered, the false clustering result will continue to exist to make the difference between the class information and the true class information increasingly greater. This greatly reduces the clustering accuracy. Therefore, content corresponding to associated information for which the clustering is uncertain shall be re-distributed to adjust and amend the clustering result.

In calculation of the connectivity of the content corresponding to the associated information with the cluster, not only the greatest connectivity will be selected, but also the second greatest connectivity will be considered. In case of a small difference therebetween, determination of the class of the content corresponding to the associated information becomes uncertain, in which case we classifies the content corresponding to the associated information without altering the cluster information so as to prevent that a false classification of content corresponding to one piece of associated information leads to an overall false classification. As the processed content data corresponding to the new associated information reaches a certain amount, re-classification of the content corresponding to the associated information of this class and combination of different classes will be considered.

When the incremental data is considered, a key problem is that there may be a large amount of data between two classes and this provides the possibility of combining these two classes. However, it is inappropriate to determine whether two classes can be combined together simply according to a center-to-center distance between the classes. Two kinds of class feature information, namely a class center vector and a class average, are defined as follows:

Class center vector:

$${c}_{j} = \frac{{\sum }_{{x}_{i} ∈ {C}_{j}} {x}_{i}}{\vert {C}_{j} \vert} \qquad ( 14 )$$

Class average:

$$\overline{{C}_{j}} = \frac{{\sum }_{i = 1}^{\vert {C}_{j} \vert} D ( {x}_{i} , {c}_{j} )}{\vert {C}_{j} \vert} \qquad ( 15 )$$

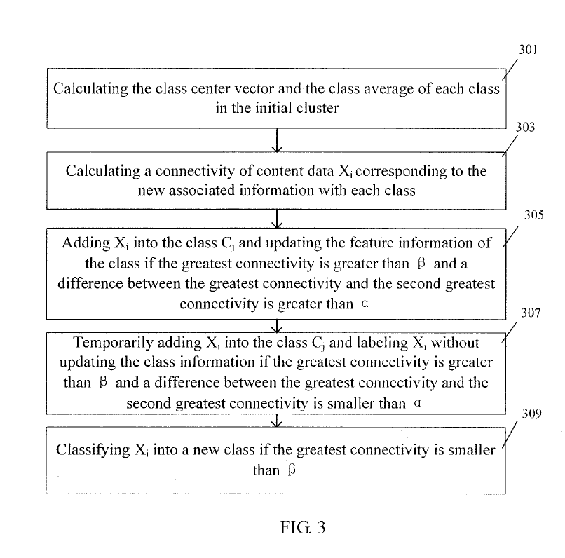

FIG. 3 shows a flowchart diagram of an incremental clustering method based on congruence. As shown in FIG. 3, steps of the incremental clustering method based on congruence are as follows:

In Step 301: calculating the class center vector and the class average of each class in the initial cluster;

In Step 303: calculating a connectivity of content data xᵢ corresponding to the new associated information with each class;

In Step 305: if the greatest connectivity max j(xᵢ, Cⱼ)>β and a difference between the greatest connectivity and the second greatest connectivity Error! Reference source not found, then adding xᵢ into the class Cⱼ and updating the feature information of the class.

In Step 307: if the greatest connectivity max j(xᵢ, Cⱼ)>β and a difference between the greatest connectivity and the second greatest connectivity Error! Reference source not found, then temporarily adding xᵢ into the class Cⱼ and labeling xᵢ without updating the class information.

In Step 309: if the greatest connectivity max j(xᵢ, Cⱼ)<β, then classifying xᵢ into a new class.

Further, determining whether the graph cluster needs to be combined with other graph clusters according to the class center vector and the class average of each of the graph cluster classes is to re-calculate the optimal number of classes of the graph cluster when contents of all the new associated information are classified into an arbitrary graph cluster class:

if the re-calculated optimal number of classes of the graph cluster is smaller or equal to the previously calculated optimal number of classes of the graph cluster, then combining the labeled content corresponding to the new associated information into the graph cluster where it is temporarily stored, and updating the class center vector and the class average of the graph cluster; and

if the re-calculated optimal number of classes of the graph cluster is larger than the previously calculated optimal number of classes of the graph cluster, then re-clustering the labeled content corresponding to the new associated information independently and calculating a class center vector and a class average of the new graph cluster.

After a certain amount of contents corresponding to the new associated information have been clustered, the temporarily stored data that have been labeled are re-classified; and an optimal number of classes k is re-calculated. If the k value is smaller than the current number of classes, then classes with the greatest congruence are combined together, and if the k value is greater than the current number of classes, the re-clustering is performed.

Calculating a relevancy between the subject vector and the existing graph cluster classes, and creating an initial result set of the subject link includes:

decomposing the query vector into at least one query component according to the subject attribute;

viewing each of the at least one query component as a keyword respectively and calculating a connectivity between each of the query component keywords and each of the graph cluster classes;

calculating a relevancy between each of the at least one query component and each of the graph cluster class according to the query component keyword and each of the graph cluster classes; and

calculating the initial result set of the query component according to the connectivity between the query component and each of the graph clusters as well as an absolute value of each of the at least one query component, wherein the initial result set is a subject link set that is closer to the query component among the graph cluster classes.

Further, calculating an average of normalized weights of the relevancy of each subject link in the initial result set and the PageRank value is to normalize and weight the relevancy of the extended result set and the PageRank value so as to obtain each relevancy to the query vector.

After the content datasets corresponding to the new associated information is clustered through an improved graph clustering process, an initial result set need be obtained according to the user's query. It is possible that a query word is associated with different classes simultaneously. In an embodiment, when the subject name “Lang Ya Bang” is putted by the user, the purpose may be to audition the theme song or to learn the name of the leading actor, the leading actress and the director, i.e., there may be two classes intersecting with each other in this dimension. Therefore, the query class shall not be determined simply according to the content spacing corresponding to the associated information. This problem is solved by adopting conditional probability in the present disclosure. Letting q be a user query vector and qᵢ be a component of the user query vector, then the probability that the user query belongs to a certain class may be calculated as follows:

$$P ( {C}_{j} \vert q ) = \frac{p ( {C}_{j} ) * P ( q \vert {C}_{i} )}{P ( q )} ∝ p ( {C}_{j} ) * {\prod }_{i} P ( {q}_{i} \vert {C}_{j} ) \qquad ( 16 )$$

Formula (16) is a variant of the Bayes formula, and the Bayes formula may be described as:

$$P ( a \vert b ) = \frac{p ( a ) * P ( b \vert a )}{P ( b )}$$

Assuming that the query components in q are independent from each other, then the following can be obtained according to the probability knowledge:

$$P ( q \vert {C}_{j} ) = {\prod }_{i} P ( {q}_{i} \vert {C}_{j} )$$

Because the denominator P(q) is usually a constant, the following holds:

$$\frac{p ( {C}_{j} ) * P ( q \vert {C}_{j} )}{P ( q )} ∝ p ( {C}_{j} ) * {\prod }_{i} P ( {q}_{i} \vert {C}_{j} )$$

P=(p₁, p₂, . . . , pₖ) is defined to represent the probability that the query q is associated with each class, and it may be considered that the greater the probability is, the greater the relevancy between the query and the class will be. A corresponding number of results are selected, according to the percentages of the probabilities, from each class as a result set of content analysis, and a reciprocal of a distance between the content corresponding to the associated information and the query is used as a weight of the content corresponding to the associated information with respect to the current query.

After the initial result set is chosen from the subject link classes, the final sorting result is determined by further taking the subject link quality (i.e., the PageRank value) into consideration. Considering that the prior art method determines the similarity between the subject link and the query completely with respect to the content, it is possible that some important associated subject links are classified into other classes due to different emphases in cases where the clustering is instable. Relevancy to such information may be established through use of the link information.

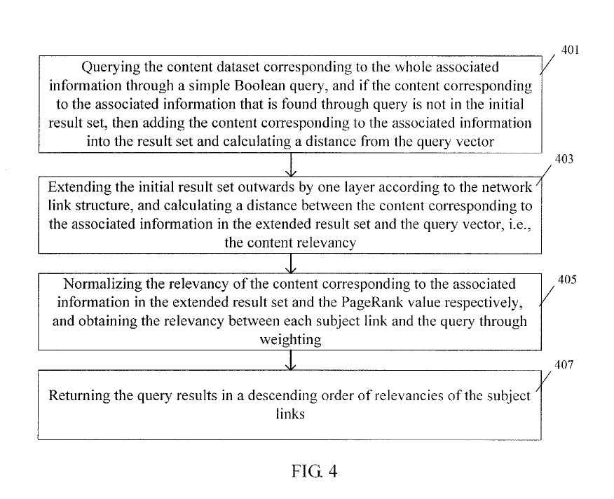

FIG. 4 is a flowchart diagram of a process for sorting subject links according to an initial result set. As shown in FIG. 4, the process includes the following steps:

In Step 401: querying the content dataset corresponding to the whole associated information through a simple Boolean query, and if the content corresponding to the associated information that is found through query is not in the initial result set, then adding the content corresponding to the associated information into the result set and calculating a distance from the query vector.

In Step 403: extending the initial result set outwards by one layer according to the network link structure, and calculating a distance between the content corresponding to the associated information in the extended result set and the query vector (i.e., the content relevancy).

In Step 405: normalizing the relevancy of the content corresponding to the associated information in the extended result set and the PageRank value respectively, and obtaining the relevancy between each subject link and the query through weighting.

In Step 407: Returning the query results in a descending order of relevancies of the subject links.

The first step avoids omission of associated subject links, the second step takes associated information of contents implied in the links into consideration and also enriches the result set, and the third step obtains the subject link sorting associated with the query by considering the content relevancy and the link importance. The final subject link scores are calculated according to the following formula:

Score(xᵢ,q)=a*CR(xᵢ)+b*PR(xᵢ) (17)

where, a an b are weight values that are set for the subject link content and the link, with a sum of a and b being l; CR(xᵢ) represents the normalized content relevancy of the content xᵢ corresponding to the associated information; and PR(xᵢ) represents the normalized PageRank value of the content xᵢ corresponding to the associated information.

The subject attribute is of a movie or TV play and the associated information of the subject name is at least one of the following: a story video, an opening song, an ending song, a leading actor, a leading actress, a director, a scriptwriter, and a story introduction; or the subject attribute is of an actor and the associated information of the subject name is at least one of the following: TV plays that the actor has played, songs that the actor has sung, news, personal data, personal portraits, and main partners; or the subject attribute is of a director, and the associated information of the subject attribute is at least one of the following: TV plays that the director has directed, news, personal data, directing styles, and main partners.

According to another embodiment of the present disclosure, a system for obtaining and sorting associated information is provided.

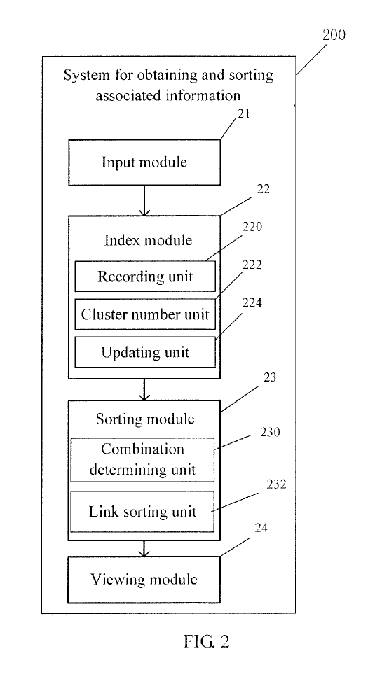

As shown in FIG. 2, the system 200 for obtaining and sorting associated information according to the embodiment of the present disclosure includes:

an input module 21, configured to obtain a subject name and a subject attribute inputted by a user;

an index module 22, configured to obtain associated information of the subject name according to the subject attribute, and obtain contents corresponding to the associated information;

a sorting module 23, configured to present the contents corresponding to the associated information to a user in sequence; and

a viewing module 24, configured to allow the user to download and view the contents corresponding to the associated information.

The index module 22 includes:

a recording unit 220, configured to search for initial associated information of the subject name along a link associated with the subject attribute, extract contents corresponding to at least one of the initial associated information in the form of a vector from the initial associated information of the subject name, and store the content corresponding to the initial associated information, the subject link and the searching time in a correlated manner;

a cluster number unit 222, configured to calculate a density-based similarity between contents corresponding to every two of the initial associated information, and determine an optimal number of classes of a graph cluster according to the density-based similarities between the contents corresponding to the initial associated information; and

an updating unit 224, configured to access an updated subject corresponding to the subject again according to the link associated with the subject attribute and search for updated subject information, update the contents corresponding to the initial associated information into contents corresponding to the new associated information according to the updated subject information, and store the contents corresponding to the new associated information, the subject link and the updating time in a correlated manner.

In some exemplary embodiments, calculating a density-based similarity between contents corresponding to every two of the initial associated information by the cluster number unit 222 includes:

defining a regional homogeneity and a global homogeneity of a graph clustering system;

obtaining a density-based line segment length distance expression according to the regional homogeneity and the global homogeneity of the graph clustering system;

calculating a density-based distance between the contents corresponding to the two of the initial associated information according to the density-based line segment length distance expression; and

obtaining the density-based similarity between the contents corresponding to the two of the initial associated information according to the density-based distance between the contents corresponding to the two of the initial associated information.

Further, determining an optimal number of classes of a graph cluster according to the density-based similarities between the contents corresponding to the initial associated information by the cluster number unit 222 includes:

creating a similarity matrix from the density-based similarities between the contents corresponding to every two of the initial associated information, wherein a row vector of the similarity matrix represents a content corresponding to one of the initial associated information and a column vector represents a weight value of a content feature term corresponding to one of the initial associated information;

calculating in the similarity matrix an average of weight values of content feature terms corresponding to all the initial associated information, an average of the content feature terms corresponding to any intra-graph-cluster initial associated information, a population variance of content datasets corresponding to all the initial associated information, a variance of any intra-graph-cluster dataset, and a variance of any inter-graph-cluster dataset; and

calculating the optimal number of classes of the graph cluster by means of the C-H exponent defined variance ratio standard according to the variance of any intra-graph-cluster dataset and the variance of any inter-graph-cluster dataset.

Further, the sorting module 23 includes:

a combination determining unit 230, configured to calculate a class center vector and a class average of the graph cluster, calculate a connectivity between the content corresponding to the new associated information and all the existing graph cluster classes, determine whether to add the content corresponding to the new associated information into a pre-existing class created using the graph clustering system according to the connectivity between the content corresponding to the new associated information and all the existing graph cluster classes, and determine whether the graph cluster needs to be combined with other graph clusters according to the class center vector and the class average of each of the graph cluster classes; and

a link sorting unit 232, configured to combine the subject name and the subject attribute inputted by the user into a subject vector, calculate a relevancy between the subject vector and the existing graph cluster classes, create an initial result set of the subject link, calculating normalized weight values of the relevancy of the content corresponding to each of the associated information in the initial result set and the PageRank value, and sort the contents in the order of the normalized weight values of the relevancy and the PageRank value for presentation to the user.

Meanwhile, determining whether to add the content corresponding to the new associated information into a pre-existing class created using the graph clustering system according to the connectivity between the content corresponding to the new associated information and all the existing graph cluster classes by the combination determining unit 230 includes:

sorting the connectivity between the content corresponding to each of the new associated information and all the existing graph cluster classes in the order of magnitudes of the connectivities;

if the greatest connectivity of the contents corresponding to the new associated information is larger than a first threshold and a difference in absolute values of the greatest connectivity and the second greatest connectivity is larger than a second threshold, then adding the content corresponding to the new associated information into the graph cluster corresponding to the greatest connectivity, and updating the class center vector and the class average of the graph cluster;

if the greatest connectivity of the content corresponding to the new associated information is larger than the first threshold but the difference in absolute values of the greatest connectivity and the second greatest connectivity is not larger than the second threshold, then temporarily storing the content corresponding to the new associated information into the graph cluster corresponding to the greatest connectivity, and labeling the content corresponding to the new associated information but not updating the class center vector and the class average of the graph cluster; and

if the greatest connectivity of the content corresponding to the new associated information is not larger than the first threshold, then classifying the content corresponding to the new associated information into a new graph cluster class and calculating a class center vector and a class average of the new graph cluster.

Further, determining whether the graph cluster needs to be combined with other graph clusters according to the class center vector and the class average of each of the graph cluster classes by the combination determining unit 230 is to re-calculate the optimal number of classes of the graph cluster when contents of all the new associated information are classified into an arbitrary graph cluster class:

if the re-calculated optimal number of classes of the graph cluster is smaller or equal to the previously calculated optimal number of classes of the graph cluster, then combining the labeled content corresponding to the new associated information into the graph cluster where it is temporarily stored, and updating the class center vector and the class average of the graph cluster; and

if the re-calculated optimal number of classes of the graph cluster is larger than the previously calculated optimal number of classes of the graph cluster, then re-clustering the labeled content corresponding to the new associated information independently and calculating a class center vector and a class average of the new graph cluster.

Calculating a relevancy between the subject vector and the existing graph cluster classes and creating an initial result set of the subject link by the link sorting unit 232 includes:

decomposing the query vector into at least one query component according to the subject attribute;

viewing each of the at least one query component as a keyword respectively and calculating a connectivity between each of the query component keywords and each of the graph cluster classes;

calculating a relevancy between each of the at least one query component and each of the graph cluster class according to the query component keyword and each of the graph cluster classes; and

calculating the initial result set of the query component according to the connectivity between the query component and each of the graph clusters as well as an absolute value of each of the at least one query component, wherein the initial result set is a subject link set that is closer to the query component among the graph cluster classes.

Further, calculating an average of normalized weights of the relevancy of each subject link in the initial result set and the PageRank value by the link sorting unit 232 is to normalize and weight the relevancy of the extended result set and the PageRank value so as to obtain each relevancy to the query vector.

The subject attribute is of a movie or TV play and the associated information of the subject name is at least one of the following: a story video, an opening song, an ending song, a leading actor, a leading actress, a director, a scriptwriter, and a story introduction; or the subject attribute is of an actor and the associated information of the subject name is at least one of the following: TV plays that the actor has played, songs that the actor has sung, news, personal data, personal portraits, and main partners; or the subject attribute is of a director, and the associated information of the subject attribute is at least one of the following: TV plays that the director has directed, news, personal data, directing styles, and main partners.

According to a further embodiment, a video playing terminal is provided.

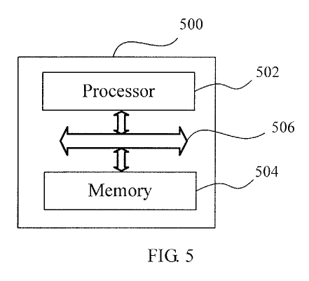

As shown in FIG. 5, the video playing terminal 500 according to the embodiment of the present disclosure includes a processor 502, a memory 504 and a bus system 506. The processor 502 and the memory 504 are connected with each other via the bus system 506. The memory 504 is configured to store instructions. The processor 502 is configured to execute instructions stored in the memory 504.

The memory 504 may be a non-transitory computer readable storage medium for storing computer executable instructions which, when being executed by one or more processors 502, enable the processor(s) 502 to execute the steps 101 to 107 of the method described in FIG. 1, or the steps 301 to 309 of the method described in FIG. 3, or the step 401 to 407 of the method described in FIG. 4. The computer executable instructions may also be stored and/or transmitted in any non-transitory computer readable storage medium for use in an instruction execution system, apparatus or device or for use in combination with an instruction execution system, apparatus or device. The instruction execution system, apparatus or device is, for example, a computer-based system, a system comprising a processor, or some other system that can obtain instructions from the instruction execution system, apparatus or device and execute the instructions. For purpose of this present disclosure, the “non-transitory computer readable storage medium” may be any tangible medium that contains or stores computer executable instructions which may be used by or in combination with the instruction execution system, apparatus or device. The non-transitory computer readable storage medium may include but is not limited to magnetic, optical and/or semiconductor storage devices. Examples of these storage devices include magnetic disks, optical disks based on CD, DVD or Blu-ray technologies, and persistent solid-state storages (e.g., flash memories, solid-state drives and etc).

As an aspect of the embodiments of the present disclosure, the system 200 for obtaining and sorting associated information in FIG. 2 described above is a computer software program system, the modules 21 to 24 and the units 220, 222, 224, 230, 232 are computer software program modules or units stored in the memory 504. In operation, the modules 21 to 24 and the units 220, 222, 224, 230, 232 are executed by the processor 502 to accomplish functions of the modules and units.

It shall be understood that, in the embodiments of this application, the processor 502 may be a central processing unit (CPU). The processor 502 may also be some other general-purpose processor, digital signal processor (DSP), application specific integrated circuit (ASIC), field programmable gate array (FPGA) or some other programmable logic element, discrete gate or transistor logic element, discrete hardware component and etc. The general-purpose processor may be a microprocessor or may be any common processor.

In addition to data buses, the bus system 506 may also include power supply buses, control buses, state signal buses and so on. However, for clarity of description, all kinds of buses are labeled as the bus system 506 in the attached drawings.

In the embodiments of the present disclosure, parts and arrangement of the video playing terminal 500 are not limited to what shown in FIG. 5, but may also include other or additional parts in various arrangements.

During the implementation, the steps of the method or modules of the apparatus described above may be implemented by integrated logic circuits in hardware form or instructions in software form in the processor 502. The steps of the methods or modules of the apparatus disclosed in the embodiments of this present disclosure may be directly embodied as hardware processors, or by a combination of hardware modules and software modules in the processor 502. The software modules may reside in a storage medium well-known in the art such as a random access memory (RAM), a flash memory, a read only memory (ROM), a programmable ROM, an electrically erasable programmable memory, or a register. The storage medium resides in the memory 504, and information stored in the memory 504 is read by the processor 502 to accomplish the steps of the method described above via hardware of the processor 502. This will not be detailed herein for purpose of simplicity.

In summary, an improved graph clustering method is used to make an analysis on the link associated with the subject attribute, an initial result set selected according to the subject name and the subject attribute inputted by the user is extended by use of the subject link structure, distances between the extended result set and the subject name and the subject attribute inputted by the user are calculated as a relevancy of the content corresponding to the associated information, and then with reference to a PageRank value that measures quality of the subject link, a relevancy score of each subject link is finally obtained and returned as the sorting result. Thereby, the efficiency and the searching experiences of the user in obtaining the associated information of the subject are improved.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

As will be understood by those of ordinary skill in the art, what described above is only embodiments of the present disclosure but is not intended to limit the present disclosure, and any modifications, equivalent replacements and alterations made within the spirit and principle of the present disclosure shall all fall within the scope of the present disclosure.

What is claimed is:

1. A method for obtaining and sorting associated information, comprising:
at an electronic device;
obtaining a subject name and a subject attribute inputted by a user;
obtaining associated information of the subject name according to the subject attribute;
obtaining contents corresponding to the associated information;
presenting the contents corresponding to the associated information to a user in sequence; and
allowing the user to download and view the contents corresponding to the associated information.

2. The method according to claim 1, wherein obtaining associated information of the subject name according to the subject attribute comprises:
searching for initial associated information of the subject name along a link associated with the subject attribute;
extracting contents corresponding to at least one of the initial associated information in the form of a vector from the initial associated information of the subject name;
storing the content corresponding to the initial associated information, the subject link and the searching time in a correlated manner;
calculating a density-based similarity between contents corresponding to every two of the initial associated information;
determining an optimal number of classes of a graph cluster according to the density-based similarities between the contents corresponding to the initial associated information;
accessing an updated subject corresponding to the subject again according to the link associated with the subject attribute and searching for updated subject information;
updating the contents corresponding to the initial associated information into contents corresponding to the new associated information according to the updated subject information; and
storing the contents corresponding to the new associated information, the subject link and the updating time in a correlated manner.

3. The method according to claim 2, wherein calculating a density-based similarity between contents corresponding to every two of the initial associated information comprises:
defining a regional homogeneity and a global homogeneity of a graph clustering method;
obtaining a density-based line segment length distance expression according to the regional homogeneity and the global homogeneity of the graph clustering method;
calculating a density-based distance between the contents corresponding to the two of the initial associated information according to the density-based line segment length distance expression; and
obtaining the density-based similarity between the contents corresponding to the two of the initial associated information according to the density-based distance between the contents corresponding to the two of the initial associated information.

4. The method according to claim 3, wherein determining an optimal number of classes of a graph cluster according to the density-based similarities between the contents corresponding to the initial associated information comprises:
creating a similarity matrix from the density-based similarities between the contents corresponding to every two of the initial associated information, wherein a row vector of the similarity matrix represents a content corresponding to one of the initial associated information and a column vector represents a weight value of a content feature term corresponding to one of the initial associated information;
calculating in the similarity matrix an average of weight values of content feature terms corresponding to all the initial associated information, an average of the content feature terms corresponding to any intra-graph-cluster initial associated information, a population variance of content datasets corresponding to all the initial associated information, a variance of any intra-graph-cluster dataset, and a variance of any inter-graph-cluster dataset; and
calculating the optimal number of classes of the graph cluster by means of the C-H exponent defined variance ratio standard according to the variance of any intra-graph-cluster dataset and the variance of any inter-graph-cluster dataset.

5. The method according to claim 2, wherein presenting the contents corresponding to the associated information to the user in sequence comprises:
calculating a class center vector and a class average of the graph cluster;
calculating a connectivity between the content corresponding to the new associated information and all the existing graph cluster classes;
determining whether to add the content corresponding to the new associated information into a pre-existing class created using the graph clustering method according to the connectivity between the content corresponding to the new associated information and all the existing graph cluster classes;
determining whether the graph cluster needs to be combined with other graph clusters according to the class center vector and the class average of each of the graph cluster classes;
combining the subject name and the subject attribute inputted by the user into a subject vector;
calculating a relevancy between the subject vector and the existing graph cluster classes;
creating an initial result set of the subject link;
calculating normalized weight values of the relevancy of the content corresponding to each of the associated information in the initial result set and the PageRank value; and
sorting the contents in the order of the normalized weight values of the relevancy and the PageRank value for presentation to the user.

6. The method according to claim 5, wherein determining whether to add the content corresponding to the new associated information into a pre-existing class created using the graph clustering method according to the connectivity between the content corresponding to the new associated information and all the existing graph cluster classes comprises:
sorting the connectivity between the content corresponding to each of the new associated information and all the existing graph cluster classes in the order of magnitudes of the connectivities;
adding the content corresponding to the new associated information into the graph cluster corresponding to the greatest connectivity if the greatest connectivity of the contents corresponding to the new associated information is larger than a first threshold and a difference in absolute values of the greatest connectivity and the second greatest connectivity is larger than a second threshold;
updating the class center vector and the class average of the graph cluster;
temporarily storing the content corresponding to the new associated information into the graph cluster corresponding to the greatest connectivity if the greatest connectivity of the content corresponding to the new associated information is larger than the first threshold but the difference in absolute values of the greatest connectivity and the second greatest connectivity is not larger than the second threshold;
labeling the content corresponding to the new associated information without updating the class center vector and the class average of the graph cluster;
classifying the content corresponding to the new associated information into a new graph cluster class if the greatest connectivity of the content corresponding to the new associated information is not larger than the first threshold; and
calculating a class center vector and a class average of the new graph cluster.

7. The method according to claim 6, wherein determining whether the graph cluster needs to be combined with other graph clusters according to the class center vector and the class average of each of the graph cluster classes comprises:
re-calculating the optimal number of classes of the graph cluster when contents of all the new associated information are classified into an arbitrary graph cluster class:
combining the labeled content corresponding to the new associated information into the graph cluster where it is temporarily stored if the re-calculated optimal number of classes of the graph cluster is smaller or equal to the previously calculated optimal number of classes of the graph cluster;
updating the class center vector and the class average of the graph cluster;
re-clustering the labeled content corresponding to the new associated information independently if the re-calculated optimal number of classes of the graph cluster is larger than the previously calculated optimal number of classes of the graph cluster; and
calculating a class center vector and a class average of the new graph cluster.

8. The method according to claim 5, wherein calculating a relevancy between the subject vector and the existing graph cluster classes, and creating an initial result set of the subject link comprises:
decomposing the query vector into at least one query component according to the subject attribute;
viewing each of the at least one query component as a keyword respectively;
calculating a connectivity between each of the query component keywords and each of the graph cluster classes;
calculating a relevancy between each of the at least one query component and each of the graph cluster class according to the query component keyword and each of the graph cluster classes; and
calculating the initial result set of the query component according to the connectivity between the query component and each of the graph clusters as well as an absolute value of each of the at least one query component, wherein the initial result set is a subject link set that is closer to the query component among the graph cluster classes.

9. The method according to claim 8, wherein calculating an average of normalized weights of the relevancy of each subject link in the initial result set and the PageRank value comprises: normalizing and weighting the relevancy of the extended result set and the PageRank value so as to obtain each relevancy to the query vector.

10. An electronic device, comprising:
at least one processor; and
a memory communicably connected with the at least one processor for storing instructions executable by the at least one processor, wherein execution of the instructions by the at least one processor causes the at least one processor to:
obtain a subject name and a subject attribute inputted by a user;
obtain associated information of the subject name according to the subject attribute;
obtain contents corresponding to the associated information;
present the contents corresponding to the associated information to a user in sequence; and
allow the user to download and view the contents corresponding to the associated information.

11. The electronic device according to claim 10, wherein obtaining associated information of the subject name according to the subject attribute comprises:
searching for initial associated information of the subject name along a link associated with the subject attribute;
extracting contents corresponding to at least one of the initial associated information in the form of a vector from the initial associated information of the subject name;
storing the content corresponding to the initial associated information, the subject link and the searching time in a correlated manner;
calculating a density-based similarity between contents corresponding to every two of the initial associated information;
determining an optimal number of classes of a graph cluster according to the density-based similarities between the contents corresponding to the initial associated information;
accessing an updated subject corresponding to the subject again according to the link associated with the subject attribute and searching for updated subject information;
updating the contents corresponding to the initial associated information into contents corresponding to the new associated information according to the updated subject information; and
storing the contents corresponding to the new associated information, the subject link and the updating time in a correlated manner.

12. The electronic device according to claim 11, wherein calculating a density-based similarity between contents corresponding to every two of the initial associated information comprises:
defining a regional homogeneity and a global homogeneity of a graph clustering method;
obtaining a density-based line segment length distance expression according to the regional homogeneity and the global homogeneity of the graph clustering method;
calculating a density-based distance between the contents corresponding to the two of the initial associated information according to the density-based line segment length distance expression; and
obtaining the density-based similarity between the contents corresponding to the two of the initial associated information according to the density-based distance between the contents corresponding to the two of the initial associated information.

13. The electronic device according to claim 12, wherein determining an optimal number of classes of a graph cluster according to the density-based similarities between the contents corresponding to the initial associated information comprises:
creating a similarity matrix from the density-based similarities between the contents corresponding to every two of the initial associated information, wherein a row vector of the similarity matrix represents a content corresponding to one of the initial associated information and a column vector represents a weight value of a content feature term corresponding to one of the initial associated information;
calculating in the similarity matrix an average of weight values of content feature terms corresponding to all the initial associated information, an average of the content feature terms corresponding to any intra-graph-cluster initial associated information, a population variance of content datasets corresponding to all the initial associated information, a variance of any intra-graph-cluster dataset, and a variance of any inter-graph-cluster dataset; and
calculating the optimal number of classes of the graph cluster by means of the C-H exponent defined variance ratio standard according to the variance of any intra-graph-cluster dataset and the variance of any inter-graph-cluster dataset.

14. The electronic device according to claim 11, wherein presenting the contents corresponding to the associated information to the user in sequence comprises:
calculating a class center vector and a class average of the graph cluster;
calculating a connectivity between the content corresponding to the new associated information and all the existing graph cluster classes;
determining whether to add the content corresponding to the new associated information into a pre-existing class created using the graph clustering method according to the connectivity between the content corresponding to the new associated information and all the existing graph cluster classes;
determining whether the graph cluster needs to be combined with other graph clusters according to the class center vector and the class average of each of the graph cluster classes;
combining the subject name and the subject attribute inputted by the user into a subject vector;
calculating a relevancy between the subject vector and the existing graph cluster classes;
creating an initial result set of the subject link;
calculating normalized weight values of the relevancy of the content corresponding to each of the associated information in the initial result set and the PageRank value; and
sorting the contents in the order of the normalized weight values of the relevancy and the PageRank value for presentation to the user.

15. The electronic device according to claim 14, wherein determining whether to add the content corresponding to the new associated information into a pre-existing class created using the graph clustering method according to the connectivity between the content corresponding to the new associated information and all the existing graph cluster classes comprises:
sorting the connectivity between the content corresponding to each of the new associated information and all the existing graph cluster classes in the order of magnitudes of the connectivities;
adding the content corresponding to the new associated information into the graph cluster corresponding to the greatest connectivity if the greatest connectivity of the contents corresponding to the new associated information is larger than a first threshold and a difference in absolute values of the greatest connectivity and the second greatest connectivity is larger than a second threshold;
updating the class center vector and the class average of the graph cluster;
temporarily storing the content corresponding to the new associated information into the graph cluster corresponding to the greatest connectivity if the greatest connectivity of the content corresponding to the new associated information is larger than the first threshold but the difference in absolute values of the greatest connectivity and the second greatest connectivity is not larger than the second threshold;
labeling the content corresponding to the new associated information without updating the class center vector and the class average of the graph cluster;
classifying the content corresponding to the new associated information into a new graph cluster class if the greatest connectivity of the content corresponding to the new associated information is not larger than the first threshold; and
calculating a class center vector and a class average of the new graph cluster.

16. The electronic device according to claim 15, wherein determining whether the graph cluster needs to be combined with other graph clusters according to the class center vector and the class average of each of the graph cluster classes comprises:
re-calculating the optimal number of classes of the graph cluster when contents of all the new associated information are classified into an arbitrary graph cluster class:
combining the labeled content corresponding to the new associated information into the graph cluster where it is temporarily stored if the re-calculated optimal number of classes of the graph cluster is smaller or equal to the previously calculated optimal number of classes of the graph cluster;
updating the class center vector and the class average of the graph cluster;
re-clustering the labeled content corresponding to the new associated information independently if the re-calculated optimal number of classes of the graph cluster is larger than the previously calculated optimal number of classes of the graph cluster; and
calculating a class center vector and a class average of the new graph cluster.

17. The electronic device according to claim 14, wherein calculating a relevancy between the subject vector and the existing graph cluster classes, and creating an initial result set of the subject link comprises:
decomposing the query vector into at least one query component according to the subject attribute;
viewing each of the at least one query component as a keyword respectively;
calculating a connectivity between each of the query component keywords and each of the graph cluster classes;
calculating a relevancy between each of the at least one query component and each of the graph cluster class according to the query component keyword and each of the graph cluster classes; and
calculating the initial result set of the query component according to the connectivity between the query component and each of the graph clusters as well as an absolute value of each of the at least one query component, wherein the initial result set is a subject link set that is closer to the query component among the graph cluster classes.

18. The electronic device according to claim 17, wherein calculating an average of normalized weights of the relevancy of each subject link in the initial result set and the PageRank value comprises: normalizing and weighting the relevancy of the extended result set and the PageRank value so as to obtain each relevancy to the query vector.

19. A non-transitory computer-readable storage medium storing executable instructions, wherein when executed by an electronic device, causes the electronic device to:
obtain a subject name and a subject attribute inputted by a user;
obtain associated information of the subject name according to the subject attribute;
obtain contents corresponding to the associated information;
present the contents corresponding to the associated information to a user in sequence; and
allow the user to download and view the contents corresponding to the associated information.

20. The non-transitory computer-readable storage medium according to claim 19, wherein obtaining associated information of the subject name according to the subject attribute comprises:
searching for initial associated information of the subject name along a link associated with the subject attribute;
extracting contents corresponding to at least one of the initial associated information in the form of a vector from the initial associated information of the subject name;
storing the content corresponding to the initial associated information, the subject link and the searching time in a correlated manner;
calculating a density-based similarity between contents corresponding to every two of the initial associated information;
determining an optimal number of classes of a graph cluster according to the density-based similarities between the contents corresponding to the initial associated information;
accessing an updated subject corresponding to the subject again according to the link associated with the subject attribute and searching for updated subject information;
updating the contents corresponding to the initial associated information into contents corresponding to the new associated information according to the updated subject information; and
storing the contents corresponding to the new associated information, the subject link and the updating time in a correlated manner.
